(19) United States
(12) Patent Application Publication
(10) Pub. No.: US 2010/0224018 A1
(43) Pub. Date: Sep. 9, 2010

(54) BALL-WEDGE TYPE SPEED REDUCER

(75) Inventors: Nung Jun Tae, Chongjin City (KP); Yong Kim, Chongjin City (KP)

Correspondence Address: Hershkovitz & Associates, LLC, 2845 Duke Street, Alexandria, VA, 22314, US

(73) Assignee: Nung Jun Tae, North Hamgyong Province (KP)

(21) Appl. No.: 11/993,438

(22) PCT Filed: Dec. 8, 2005
(86) PCT No.: PCT/KP05/00006

§ 371 Date: Dec. 20, 2007

(30) Foreign Application Priority Data
Jun. 20, 2005 (KP) KP-05-129

(51) Int. Cl. F16H 57/00

(52) U.S. Cl. 74/406

(57) ABSTRACT

The speed reducer according to the present invention is based on the wedge principle, and comprises an input shaft (1), an output shaft (10), an input cylinder (4) having a first wedge profile on its one side, an output cylinders (8) having a second wedge profile, a plurality of balls (7) positioned between said input and output cylinders (4,8), and a guide sleeve (5) having a plurality of horizontal grooves with semicircular cross section in its inner surface.

### TECHNICAL FIELD OF THE INVENTION

This invention relates to a speed reducer, and particularly to a speed reducer based on the principle of force increase at the wedge, comprising an input cylinder, output cylinder, a plurality of balls and guide sleeve.

### BACKGROUND OF THE INVENTION

EP 0207206 A2 discloses a gearless speed reducer comprising first and second discs disposed to face each other so as to transfer the rotation of the former to the latter; sinuous grooves provided in the facing sides of said first and second discs and arranged in a closed loop; and rollable balls arranged between said first and second discs and positioned in said grooves so as to roll along the grooves, at the same time transmitting rotation of said first disc to said second disc. The reducer further comprises a rectifier disc placed to face the second disc, and means arranged between the second disc and the rectifier disc to transmit the movement of the second disc to the rectifier disc, while modifying the movement of the second disc into that of rotation.

Such conventional reducers utilizing balls to transmit the rotation of the input disk to that of the output disk have some problems including severe wear of components because point contact between the guide groove and ball, and impossible to apply to the application requiring great power transmission due to short length of contact between the balls and input disk or output disk. Furthermore, the conventional reducers of this kind have a relatively small reduction ratio and large radial dimension.

### SUMMARY OF THE INVENTION

Therefore, an object of the invention is to provide a ball-wedge type speed reducer having small size and weight, being cost effective and of high reduction ratio.

The speed reducer according to the present invention comprises an input and output cylinders fixed to an input shaft and an output shaft respectively, and arranged to face each other, a plurality of balls positioned between the input and output cylinders, a guide sleeve and a housing, wherein the input cylinder is provided on the facing side thereof with first number of wedges in a closed loop, each of the wedges having an axis perpendicular to the longitudinal axis of the input cylinder, the output cylinder is provided on the facing side thereof with second number of wedges in a closed loop, each of the wedges having an axis in parallel with a longitudinal axis of the output cylinder, the guide sleeve has a plurality of linear grooves with semicircular cross section, in parallel to the output shaft and formed in the inner surface thereof to receive the balls therein. So when the input shaft rotates, the balls reciprocate along the linear grooves so as to rotate the output cylinder.

Preferably, outer faces of the wedges of input cylinder and output cylinder are in the form of circular arc to provide a line contact between the wedge and the ball.

In one embodiment of the speed reducer according to the present invention, said guide sleeve is firmly secured to the housing.

In another embodiment of the invention, the reducer further comprises a differential device to rotate the guide sleeve in the same rotating direction of the input shaft and comprising first external gear fixed to the input shaft, second external gear meshing with the first external gear and rigidly connected to a third gear, and a forth external gear formed integral with the guide sleeve and meshing with the third external gear, wherein said second and third external gears are fitted on a stationary shaft fixed to a front cover by a proper fastening means and in parallel with but apart from the input shaft, so as to rotate about the stationary shaft.

These and other objects, characteristics. and advantages of the present invention will become readily apparent from the ensuing detailed description thereof.

### BRIEF DESCRIPTION OF THE DRAWINGS

For a fuller understanding of the invention, reference should now be made to the detailed description thereof in conjunction with the accompanying drawings, wherein:

FIG. 1 is a schematic view of a ball-wedge type speed reducer according to the present invention;

FIG. 2 is a kinematic diagram of a ball-wedge type speed reducer according to the present invention;

FIG. 3 is a perspective view of one embodiment of a ball-wedge type speed reducer according to the present invention; and

FIG. 4 is a perspective view of a differential ball-wedge type speed reducer according to the present invention.

### DETAILED DESCRIPTION OF PREFERRED EMBODIMENTS

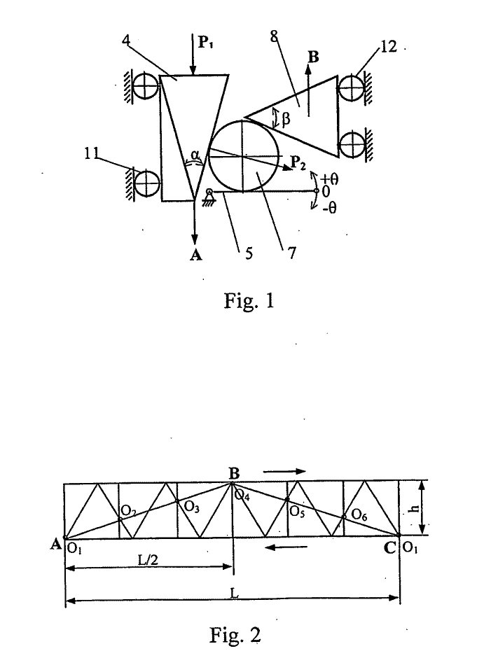

FIG. 1 shows a principle of power transmission at a speed reducer according to the present invention. First wedge 4 and second wedge 8 are arranged in perpendicular each other, and their between a ball 7 is located. In such arrangement, if external force P₁ is applied to the first wedge 4, then the ball 2 receives force P₂ according to the wedge principle, therefore moves along a guide 5, which leads to the movement of second wedge 8 along the bearing 12, as indicated by arrow B. If the guide 5 is shifted towards the arrow +θ, then movement of the second wedge 8 will be accelerated, and if towards the arrow −θ, then the movement of the second wedge 8 will be reduced.

FIG. 2 shows the arrangement of several isosceles triangles (shown as 5 triangles in the figure) overlaid with an isosceles triangle ABC having a length L of its bottom side and height h. Balls are placed at points intersected with each other. Now, if the big triangle ABC moves left as shown, then the balls O₁, O₂ and O₃ will go upwards, hereby push the small triangles to the right, and rest balls O₄, O₅, O₆ will come down due to the movement of small triangles to the right. If the big triangle moves as much as L/2 l to the left, then the small triangles move as much as L/(2*Z), in which Z is a number of small triangles.

A speed reducer made by applying the above principle considered under the plane condition to a cylinder is the ball-wedge type speed reducer invented and designated by the present inventor.

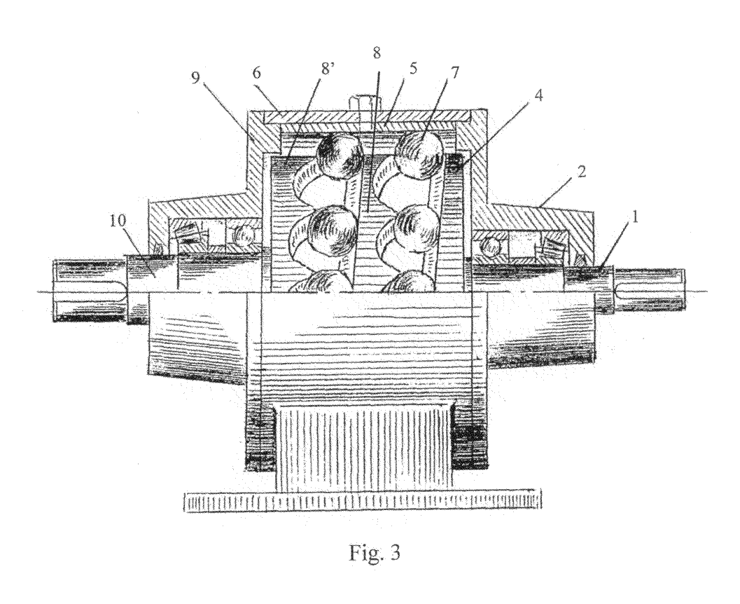

FIG. 3 shows one embodiment of two-stage ball-wedge type speed reducer according to the present invention. The reducer comprises a first stage 1, second stage 10, an input shaft 1 extending through a central hole of a front cover 2 and rotatable about its own axis and an output shaft 10. The first stage comprises a first wheel 4 and second wheel 8 facing each other, and balls 7 positioned there between. On the facing side of the first wheel 4, one wedge having its axis perpendicular to the input shaft 1 is formed in a closed loop, and on the facing side of the second wheel 8, several wedges having its axis parallel to the input shaft 1 are formed in a closed loop. On the other side of the second wheel, there is formed one wedge having an axis perpendicular to the input shaft 1, in a closed loop. The second stage comprises the second wheel 8 and a third wheel 8′ facing each other, and balls 7 positioned there between. On the facing side of the third wheel 8′, several wedges having its axis parallel to the input shaft 1 are formed in a closed loop. Around circumference of said wheels a guide sleeve is positioned, in inner surface of which several horizontal grooves with semi circular cross section are formed to guide the balls 7, the grooves being in parallel with the input shaft 1.

Though the guide sleeve 5 is presented as a single member, separate guide sleeves 5 can be installed for each stage, in particular if the wedge number of side of the second wheel facing the first wheel differs from that of third wheel. Number of balls of each stage is much as one than that of the horizontal grooves of the guide sleeve.

The reducer operates as following: when the input wheel 4 rotates, the balls 7 of the first stage move horizontally along the guide sleeve 5 due to the wedge of the first wheel 4, thereby lead to rotation of the second wheel 8 at reduced speed. Then the balls 7 of the second stage move due to the wedge of opposite side of the second wheel 8 facing the third wheel so as to rotate the third wheel 8′ at reduced speed.

In general, reduction ratio of the present reducer is as following:

i=Z₂/Z₁, wherein Z₁ is a number of wedge of input wheel and Z₂ is a number of output wheel.

Therefore, if the wedge number of input wheel is one, then the reduction ratio equals to the wedge number of output wheel.

Reduction ratio of two-stage reducer is calculated by multiplying ratios of separate stage.

For example, if wedge number of first wheel is one, that of first and second sides of the second wheel are seven and one, that of third wheel is seven, then the gear ratio becomes forty-nine.

The ball-wedge type speed reducer according to the present invention has a self-locking feature, since the angle of wedge of the input shaft is extremely small.

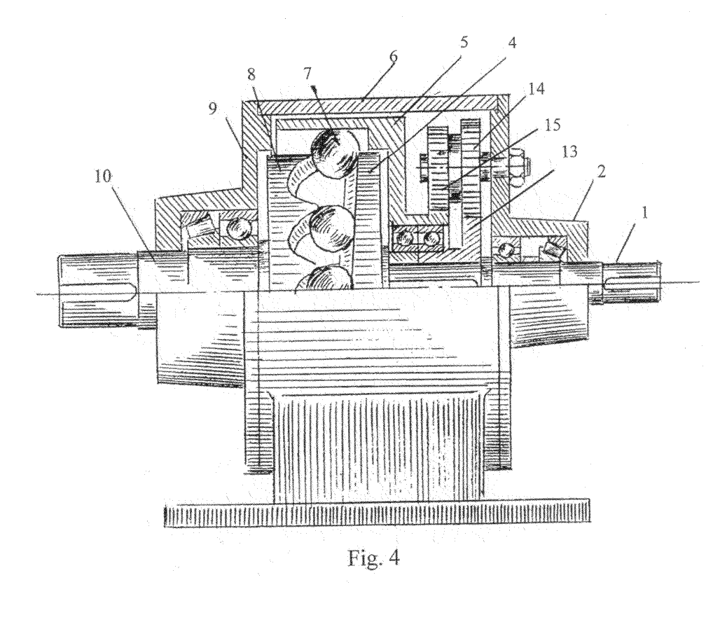

FIG. 4 shows a differential ball-wedge type speed reducer according to the present invention, which has very high reduction ratio. This reducer is one modified according to the principle mentioned with regard to the FIG. 1 such that the guide sleeve 5, which is stationary at the above-mentioned single-stage ball-wedge reducer, is connected to a differential device so as to rotate in the same rotational direction. Specifically, the differential device comprises a first external gear 13 fixed to the input shaft 1, a second external gear 14 meshing with the first external gear 13 and rigidly connected to a third gear 15, and a forth external gear formed integral with the guide sleeve 5 and meshing with the third external gear 15.

When the wedge number (Z₁) of the first wheel 1 is one, that (Z₈) of the output wheel is twelve, teeth number (Z₁₃) of the first gear 13 of the differential device is fifty, that (Z₁₄, Z₁₅) of the second gear and third gear is thirty, respectively, and that (Z₅) of the fourth gear is fifty one, the gear ratio (i) amounts to Z₈*Z₅=12*51=612.

Preferred embodiments of the present invention have now been described; however, changes will obviously occur to those skilled in the art without departing from the spirit thereof. For example, in the embodiment shown at FIG. 3, if the output shaft is fixed not to rotate, then the housing 10 will rotate. Hence, this embodiment can be utilized as a winch, if the housing is modified to be a rope sheave.

It is therefore, intended that the invention is to be limited only by the scope of the appended claims.

1-5. (canceled)

6. A speed reducer comprising input and output cylinders fixed to an input shaft and an output shaft respectively, and arranged to face each other, a plurality of balls positioned between said input and output cylinders, a guide sleeve and a housing, wherein the input cylinder is provided on a facing side thereof with one wedge in a closed loop, the wedge having an axis perpendicular to a longitudinal axis of the input cylinder, the output cylinder is provided on a facing side thereof with a plurality of wedges in a closed loop, each of the wedges having an axis in parallel with a longitudinal axis of the output cylinder, the guide sleeve has a plurality of horizontal grooves with semicircular cross section, in parallel to the output shaft and formed in the inner surface thereof to receive the balls therein, so that rotation of the input shaft causes reciprocation movement of the balls along horizontal grooves so as to rotate the output cylinder.

7. The speed reducer of claim 6, wherein outer faces of the wedges of the input cylinder and the output cylinder are in the form of a circular arc to provide a line contact between the wedge and the ball.

8. The speed reducer of claim 6, wherein said guide sleeve is fixed to the housing.

9. The speed reducer of claim 7, wherein said guide sleeve is fixed to the housing.

10. The speed reducer of claim 6, wherein the reducer further comprises a differential device to rotate the guide sleeve in the same rotational direction of the input shaft.

11. The speed reducer of claim 7, wherein the reducer further comprises a differential device to rotate the guide sleeve in the same rotational direction of the input shaft.

12. The speed reducer of claim 10, wherein the differential device comprises a first external gear fixed to the input shaft, a second external gear meshing with the first external gear and rigidly connected to a third gear, and a fourth external gear formed integral with the guide sleeve and meshing with the third external gear, wherein said second and third external gears are fitted on a stationary shaft fixed to a front cover by a proper fastening means and in parallel with but apart from the input shaft, so as to rotate about the stationary shaft.

13. The speed reducer of claim 11, wherein the differential device comprises a first external gear fixed to the input shaft, a second external gear meshing with the first external gear and rigidly connected to a third gear, and a fourth external gear formed integral with the guide sleeve and meshing with the third external gear, wherein said second and third external gears are fitted on a stationary shaft fixed to a front cover by a proper fastening means and in parallel with but apart from the input shaft, so as to rotate about the stationary shaft.
